(19) United States
(12) Patent Application Publication
(10) Pub. No.: US 2021/0048311 A1
(43) Pub. Date: Feb. 18, 2021

(54) SYSTEMS AND METHODS FOR ON-DEMAND SERVICES

(71) Applicant: BEIJING DIDI INFINITY TECHNOLOGY AND DEVELOPMENT CO., LTD., Beijing (CN)

(72) Inventors: Ji ZHAO, Beijing (CN); Huan CHEN, Beijing (CN); Peng YU, Beijing (CN); Qi SONG, Beijing (CN)

(73) Assignee: BEIJING DIDI INFINITY TECHNOLOGY AND DEVELOPMENT CO., LTD., Beijing (CN)

(21) Appl. No.: 17/087,644

(22) Filed: Nov. 3, 2020

Related U.S. Application Data
(63) Continuation of application No. PCT/CN2018/089773, filed on Jun. 4, 2018.

(51) Int. Cl. G01C 21/00; H04W 4/029; H04W 4/40; G01C 21/34

(52) U.S. Cl. CPC G01C 21/3811; G01C 21/3476; H04W 4/40; H04W 4/029

(57) ABSTRACT

A method for online to offline services is provided. The method may include one or more of the following operations. A transportation service request may be received. The transportation service request may include a target address query from a user terminal. Whether the target address query is directed to a target area of interest (AOI) may be determined. At least one target point of interest (POI) and a target semantic description associated with the target AOI may be obtained from an AOI database. The at least one target POI and the target semantic description may be sent to the user terminal.

### CROSS-REFERENCE TO RELATED APPLICATIONS

This application is a continuation of International Patent Application No. PCT/CN2018/089773, filed on Jun. 4, 2018, which designates the United States of America, the contents of which are hereby incorporated by reference in their entirety.

### TECHNICAL FIELD

The present disclosure generally relates to systems and methods for online to offline services, and in particular, to systems and methods for recommending at least one point of interest (POI) and/or a semantic description associated with a transportation service request to a user terminal.

### BACKGROUND

Online to offline services utilizing Internet technology have become increasingly popular. Take on-demand transportation services (e.g., taxi hailing services) as an example, a user can initiate a service request by inputting an address query (e.g., an address query associated with a destination) via a user terminal. After receiving the service request, a system providing on-demand services may provide a navigation service for the service request and estimate service information (e.g., an estimated time of arrival, an estimated service fee) associated with the service request. However, in some situations, the user may input an address query corresponding to a relatively large region (e.g., a road, a community), which may result in a deviation associated with the navigation service and/or the service information. Therefore, it is desirable to provide systems and methods for recommending a POI corresponding to a relatively small region (e.g., a building) or a specific location to the user as a destination when the user intends to initiate a service request.

### SUMMARY

In a first aspect of the present disclosure, a system for providing online on-demand transportation service to a user may include at least one computer-readable storage medium which has a set of instructions and at least one processor in communication with the at least one computer-readable storage medium. When executing the instructions, the at least one processor may be directed to perform a method including one or more of the following operations. A transportation service request may be received. The transportation service request may include a target address query from a user terminal. Whether the target address query is directed to a target area of interest (AOI) may be determined. At least one target point of interest (POI) and a target semantic description associated with the target AOI may be obtained from an AOI database. The at least one target POI and the target semantic description may be sent to the user terminal.

In some embodiments, the at least one processor may be further directed to perform one or more of the following operations. At least one target location associated with the target AOI may be obtained from the AOI database. The at least one target location may be sent to the user terminal.

In some embodiments, when executing the instructions to establish the AOI database, the at least one processor may be directed to perform one or more of the following operations. A record database that includes a plurality of indexed historical transportation trip records may be accessed. Each of the plurality of historical transportation trip records may include an address query from a user as a destination name of a transportation trip and an actual destination location that the transportation trip ended. A set of historical transportation trip records may be obtained from the record database. The address query of each of the set of historical transportation trip records may semantically direct to a same AOI. One or more candidate destination points may be identified based on a distribution of the actual destination locations corresponding to the set of historical transportation trip records. One or more candidate POIs may be identified based on the one or more candidate destination points. A semantic description may be associated with the AOI with the one or more candidate POIs. A data structure may be written in the at least one non-transitory storage medium. The data structure may include the address query, the one or more candidate POIs, the AOI, the semantic description, and the one or more candidate destination points.

In some embodiments, when executing the instructions to identify the one or more candidate destination points, the at least one processor may be directed to perform one or more of the following operations. The actual destination locations corresponding to the set of historical transportation trip records may be clustered into one or more point clusters. The one or more candidate destination points may be determined based on the one or more point clusters.

In some embodiments, when identify the one or more candidate destination points, the at least one processor may be directed to perform one or more of the following operations. One or more target point clusters may be selected from the one or more point clusters. Densities of the one or more target point clusters may be larger than a first threshold. One or more center coordinates of the one or more target point clusters may be determined. The one or more candidate destination points may be determined based on the one or more center coordinates.

In some embodiments, when executing the instructions to identify the one or more candidate POIs based on the one or more candidate destination points, the at least one processor may be directed to perform one or more of the following operations. For each of the one or more candidate destination points, at least one POI with a distance from the candidate destination point less than a second threshold may be identified as a candidate POI.

In some embodiments, the AOI may be associated with an area greater than a threshold area.

In some embodiments, the AOI may include one or more POIs.

In some embodiments, the one or more candidate POIs may be different from the one or more candidate destination points.

In a second aspect of the present disclosure, a method may be implemented on a computing device. The computing device may have at least one processor, at least one computer-readable storage medium, and a communication platform connected to a network. The method may include one or more of the following operations. A transportation service request may be received. The transportation service request may include a target address query from a user terminal. Whether the target address query is directed to a target area of interest (AOI) may be determined. At least one target point of interest (POI) and a target semantic description associated with the target AOI may be obtained from an AOI database. The at least one target POI and the target semantic description may be sent to the user terminal.

In a third aspect of the present disclosure, a non-transitory computer-readable storage medium may store instructions that, when executed by at least one processor of a system, cause the system to perform a method including one or more of the following operations. A transportation service request may be received. The transportation service request may include a target address query from a user terminal. Whether the target address query is directed to a target area of interest (AOI) may be determined. At least one target point of interest (POI) and a target semantic description associated with the target AOI may be obtained from an AOI database. The at least one target POI and the target semantic description may be sent to the user terminal.

In a fourth aspect of the present disclosure, a system for providing online on-demand transportation service to a user may include at least one computer-readable storage medium which has a set of instructions and at least one processor in communication with the at least one computer-readable storage medium. When executing the instructions, the at least one processor may be directed to perform a method including one or more of the following operations. A communication request may be received and accepted from a user terminal. A customer application executing on the user terminal may be detected. The customer application may collect user input from the user terminal from one or more sensors of the user terminal and may automatically communicate with the system over a network. The customer application executing on the user terminal may be communicated with to receive a transportation service request including a target address query input by a user. An area of interest (AOI) database may be accessed to obtain target data. The target data may associate the target address query with a target AOI, and may associate the target AOI with at least one target point of interest (POI) and a target semantic description associated with the target AOI. The target AOI, the at least one target POI, and the target semantic description may be written to a cache of the system. The at least one target POI and the target semantic description as well as a command may be sent to an output port of the system. The command may be configured to direct the output port to send communication signals to direct the user terminal to display on a screen of the user terminal the at least one target POI as well as the target semantic description as a recommended destination of the transportation service request.

In a fifth aspect of the present disclosure, a method may be implemented on a computing device. The computing device may have at least one processor, at least one computer-readable storage medium, and a communication platform connected to a network. The method may include one or more of the following operations. A communication request may be received and accepted from a user terminal. A customer application executing on the user terminal may be detected. The customer application may collect user input from the user terminal from one or more sensors of the user terminal and may automatically communicate with the system over a network. The customer application executing on the user terminal may be communicated with to receive a transportation service request including a target address query input by a user. An area of interest (AOI) database may be accessed to obtain target data. The target data may associate the target address query with a target AOI, and may associate the target AOI with at least one target point of interest (POI) and a target semantic description associated with the target AOI. The target AOI, the at least one target POI, and the target semantic description may be written to a cache of the system. The at least one target POI and the target semantic description as well as a command may be sent to an output port of the system. The command may be configured to direct the output port to send communication signals to direct the user terminal to display on a screen of the user terminal the at least one target POI as well as the target semantic description as a recommended destination of the transportation service request.

In a sixth aspect of the present disclosure, a non-transitory computer-readable storage medium may store instructions that, when executed by at least one processor of a system, cause the system to perform a method including one or more of the following operations. A communication request may be received and accepted from a user terminal. A customer application executing on the user terminal may be detected. The customer application may collect user input from the user terminal from one or more sensors of the user terminal and may automatically communicate with the system over a network. The customer application executing on the user terminal may be communicated with to receive a transportation service request including a target address query input by a user. An area of interest (AOI) database may be accessed to obtain target data. The target data may associate the target address query with a target AOI, and may associate the target AOI with at least one target point of interest (POI) and a target semantic description associated with the target AOI. The target AOI, the at least one target POI, and the target semantic description may be written to a cache of the system. The at least one target POI and the target semantic description as well as a command may be sent to an output port of the system. The command may be configured to direct the output port to send communication signals to direct the user terminal to display on a screen of the user terminal the at least one target POI as well as the target semantic description as a recommended destination of the transportation service request.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device on which a terminal may be implemented according to some embodiments of the present disclosure;

FIG. 4 is a block diagram illustrating an exemplary processing engine according to some embodiments of the present disclosure;

FIG. 5 is a flowchart illustrating an exemplary process for determining at least one target POI and/or a target semantic description associated with a transportation service request according to some embodiments of the present disclosure;

FIG. 6 is a block diagram illustrating an exemplary database determination module according to some embodiments of the present disclosure;

FIG. 7 is a flowchart illustrating an exemplary process for establishing an area of interest (AOI) database according to some embodiments of the present disclosure;

FIG. 8 is a schematic diagram illustrating an exemplary process for determining a candidate POI according to some embodiments of the present disclosure;

FIGS. 9A and 9B are schematic diagrams illustrating exemplary data structures according to some embodiments of the present disclosure;

FIG. 10A is a schematic diagram illustrating an exemplary user interface for recommending at least one target POI to a user according to some embodiments of the present disclosure; and

FIG. 10B is a schematic diagram illustrating an exemplary user interface for sending a target location to a user according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding on-demand transportation service, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “passenger,” “requester,” “requestor,” “service requester,” “service requestor” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

As aspect of the present disclosure relates to systems and methods for recommending at least one target point of interest (POI) associated with a transportation service request to a user. A platform providing on-demand services may receive a transportation service request from a user terminal. The transportation service request may include a target address query inputted by a user as an intended destination of the transportation service request. In some situations, the target address query may correspond to a relatively large region (e.g., a road, a community) which can be referred to as an area of interest (AOI). If the user initiates the transportation service request with the target address query as a destination, a deviation may occur in a navigation service provided by the platform and/or service information (e.g., an estimated time of arrival, an estimated service fee) associated with the transportation service request.

In order to solve this problem, the systems and methods may recommend at least one target POI associated with the AOI to the user, and the user can select one of the at least one target POI as the destination of the transportation service request. The systems and methods may determine the at least one target POI based on a distribution of actual destination locations in a plurality of historical transportation trip records. Therefore, it can improve accuracy of the destination and reduce the deviation in the navigation service provided by the platform and/or the service information associated with the transportation service request.

It should be noted that online on-demand transportation service, such as online taxi-hailing including taxi hailing combination services, is a new form of service rooted only in post-Internet era. It provides technical solutions to users and service providers that could raise only in post-Internet era. In pre-Internet era, when a passenger hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi, however, allows a user of the service to real-time and automatically distribute a service request to a vast number of individual service providers (e.g., taxi) distance away from the user. It also allows a plurality of service providers to respond to the service request simultaneously and in real-time. Therefore, through the Internet, the online on-demand transportation systems may provide a much more efficient transaction platform for the users and the service providers that may never meet in a traditional pre-Internet transportation service system.

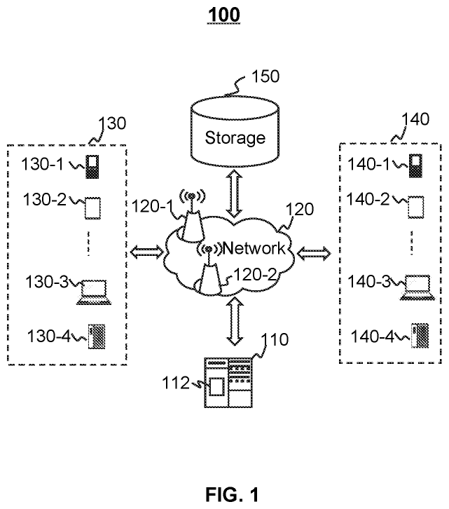

FIG. 1 is a schematic diagram illustrating an exemplary on-demand service system according to some embodiments of the present disclosure. In some embodiments, the on-demand service system may be a system for online to offline services. For example, the on-demand service system 100 may be an online transportation service platform for transportation services such as taxi hailing, chauffeur services, delivery vehicles, express car, carpool, bus service, driver hiring and shuttle services. The on-demand service system 100 may include a server 110, a network 120, a requester terminal 130, a provider terminal 140, and a storage 150.

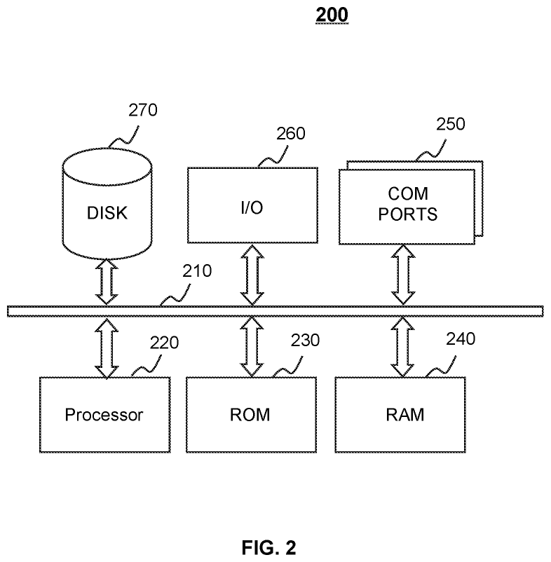

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage 150 via the network 120. As another example, the server 110 may be directly connected to the requester terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may determine at least one target POI associated with a transportation service request from the requester terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the on-demand service system 100 (e.g., the server 110, the requester terminal 130, the provider terminal 140, or the storage 150) may transmit information and/or data to other component(s) of the on-demand service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the on-demand service system 100 may be connected to the network 120 to exchange data and/or information.

In some embodiments, a service requester may be a user of the requester terminal 130. In some embodiments, the user of the requester terminal 130 may be someone other than the service requester. For example, a user A of the requester terminal 130 may use the requester terminal 130 to transmit a service request for a user B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a user D, and/or information or instructions from the server 110. In some embodiments, “service requester” and “requester terminal” may be used interchangeably, and “service provider” and “provider terminal” may be used interchangeably.

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the service requester and/or the requester terminal 130.

In some embodiments, the provider terminal 140 may be similar to, or the same device as the requester terminal 130. In some embodiments, the provider terminal 140 may be a device with positioning technology for locating the position of the service provider and/or the provider terminal 140. In some embodiments, the requester terminal 130 and/or the provider terminal 140 may communicate with other positioning device to determine the position of the service requester, the requester terminal 130, the service provider, and/or the provider terminal 140. In some embodiments, the requester terminal 130 and/or the provider terminal 140 may send positioning information to the server 110.

The storage 150 may store data and/or instructions. In some embodiments, the storage 150 may store data obtained from the requester terminal 130 and/or the provider terminal 140. In some embodiments, the storage 150 may store data and/or instructions that the server 110 may execute or use to perform exemplary methods described in the present disclosure. In some embodiments, storage 150 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the on-demand service system 100 (e.g., the server 110, the requester terminal 130, or the provider terminal 140). One or more components of the on-demand service system 100 may access the data or instructions stored in the storage 150 via the network 120. In some embodiments, the storage 150 may be directly connected to or communicate with one or more components of the on-demand service system 100 (e.g., the server 110, the requester terminal 130, the provider terminal 140). In some embodiments, the storage 150 may be part of the server 110.

In some embodiments, one or more components of the on-demand service system 100 (e.g., the server 110, the requester terminal 130, the provider terminal 140) may have permissions to access the storage 150. In some embodiments, one or more components of the on-demand service system 100 may read and/or modify information related to the service requester, service provider, and/or the public when one or more conditions are met. For example, the server 110 may read and/or modify one or more service requesters' information after a service is completed. As another example, the server 110 may read and/or modify one or more service providers' information after a service is completed.

In some embodiments, information exchanging of one or more components of the on-demand service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the on-demand service system 100 performs, the element may perform through electrical signals and/or electromagnetic signals. For example, when the requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, the provider terminal 140 may process a task through operation of logic circuits in its processor, and receive an instruction and/or a service request from the server 110 via electrical signals or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium (e.g., the storage 150), it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device according to some embodiments of the present disclosure. In some embodiments, the server 110, the requester terminal 130, and/or the provider terminal 140 may be implemented on the computing device 200. For example, the processing engine 112 may be implemented on the computing device 200 and configured to perform functions of the processing engine 112 disclosed in this disclosure.

The computing device 200 may be used to implement any component of the on-demand service system 100 as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms to distribute the processing load.

The computing device 200, for example, may include COM ports 250 connected to and from a network connected thereto to facilitate data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, and a read only memory (ROM) 230, or a random access memory (RAM) 240, for various data files to be processed and/or transmitted by the computing device. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

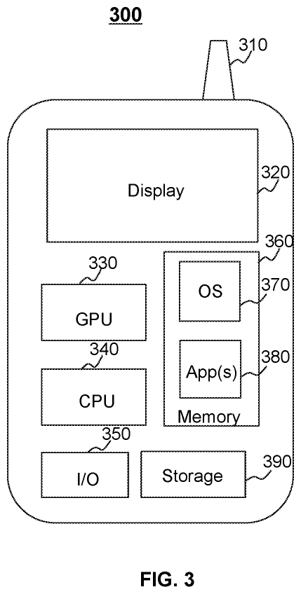

FIG. 3 is a schematic diagram illustrating exemplary hardware and/or software components of an exemplary mobile device 300 on which the requester terminal 130 and/or the provider terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, and a storage 390. In some embodiments, any other suitable component, including but not limited to a system bus or a controller (not shown), may also be included in the mobile device 300.

In some embodiments, the mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to service requests or other information from the on-demand service system 100. User interactions with the information stream may be achieved via the I/O 350 and provided to the processing engine 112 and/or other components of the on-demand service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

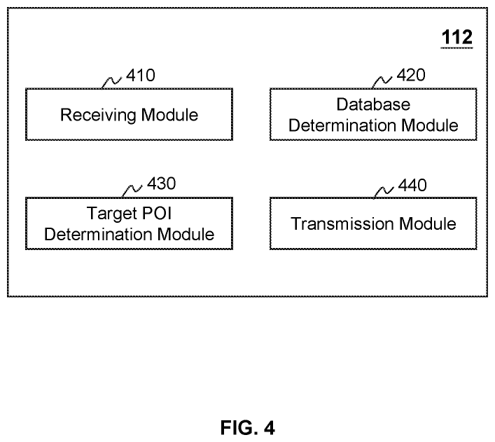

FIG. 4 is a block diagram illustrating an exemplary processing engine 112 according to some embodiments of the present disclosure. The processing engine 112 may include a receiving module 410, a database determination module 420, a target POI determination module 430, and a transmission module 440.

The receiving module 410 may be configured to receive information associated with a service request. For example, the receiving module 410 may receive a transportation service request including a target address query from the requester terminal 130 via the network 120. The target address query included in the transportation service request may refer to a name of an intended target destination of a target transportation trip associated with the transportation service request.

In some embodiments, after receiving the transportation service request, the receiving module 410 may further determine whether the target address query is directed to a target area of interest (AOI). As used herein, “the target address query is directed to a target AOI” may refer to that the name of the intended target destination is the same as or substantially similar to a name of the target AOI. As used herein, “substantially similar” refers to that a similarity between the name of the intended target destination and the name of the target AOI is larger than a threshold (e.g., 90%, 95%, 98%).

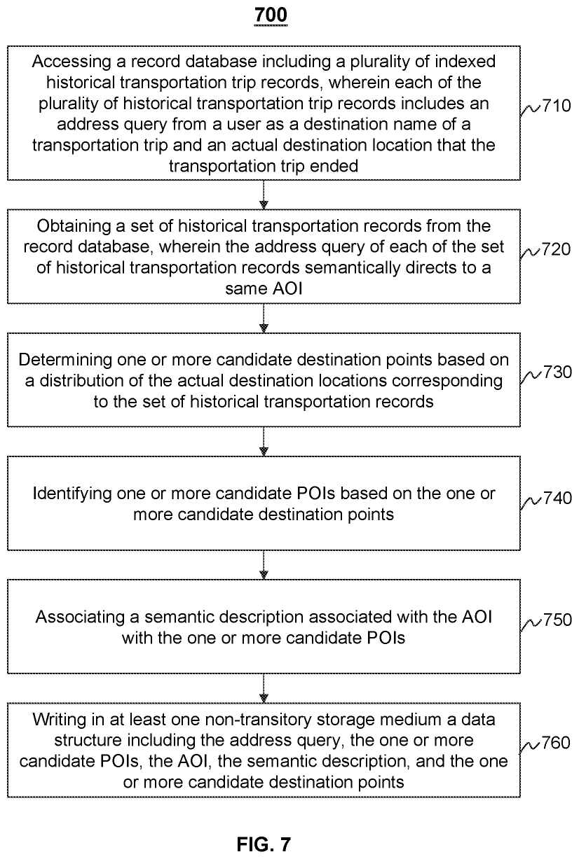

The database determination module 420 may be configured to determine an AOI database. The AOI database may include data associated with a plurality of AOIs. Take a specific AOI as an example, the AOI database includes data which associate an address query with the specific AOI, and associate the specific AOI with at least one POI, a semantic description associated with the specific AOI, and/or at least one location associated with actual destination locations in a plurality of historical transportation trip records. In some embodiments, the database determination module 420 may determine the AOI database based on the plurality of historical transportation trip records (see, e.g., FIG. 7 and the description thereof).

The target POI determination module 430 may be configured to determine at least one target POI, a target semantic description, and/or at least one target location associated with the target AOI. For example, the target POI determination module 430 may obtain the at least one target POI, the target semantic description, and/or the at least one target location associated with the target AOI from the AOI database.

The transmission module 440 may be configured to transmit information and/or instructions to one or more components in the on-demand service system 100. For example, the transmission module 440 may send the at least one target POI, the target semantic description, and/or the at least one target location to the requester terminal 130 to be displayed.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the receiving module 410 and the transmission module 440 may be combined as a single module which may both receive a transportation service request and transmit the target POI, the target semantic description, and/or the target location to the requester terminal 130. As another example, the processing engine 112 may include a storage module (not shown) used to store information and/or data (e.g., the target address query, the target POI, the target semantic description, the target location) associated with the transportation service request.

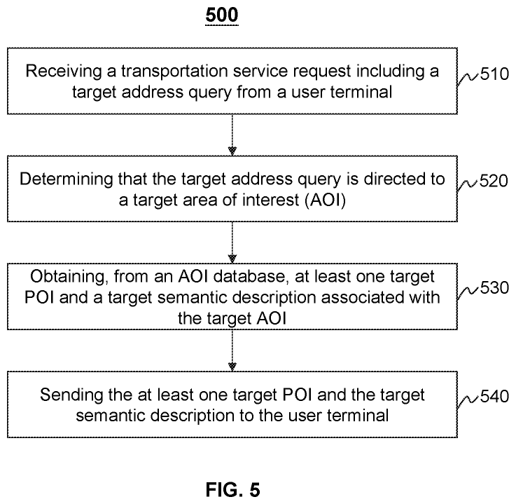

FIG. 5 is a flowchart illustrating an exemplary process for determining at least one target POI and/or a target semantic description associated with a transportation service request according to some embodiments of the present disclosure. In some embodiments, the process 500 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 500. The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the processing engine 112 (e.g., the receiving module 410) (e.g., the interface circuits of the processor 220) may receive a transportation service request (e.g., a taxi service request) including a target address query from the requester terminal 130.

For example, the processing engine 112 may receive and accept a communication request from the requester terminal 130, detect a customer application (e.g., a taxi-hailing application) executing on the requester terminal 130, and communicate with the customer application to receive the transportation service request. The customer application may collect user input from the requester terminal 130 from one or more sensors of the requester terminal 130 and automatically communicate with the on-demand service system 100 over the network 120.

In some embodiments, the transportation service request may include a real-time service request, an appointment service request, and/or any other request for one or more types of transportation services. As used herein, the real-time service request may indicate that a user wishes to use a transportation service at the present moment or at a defined time reasonably close to the present moment for an ordinary person in the art. For example, a service request may be a real-time service request if the defined time is shorter than a threshold value, such as 1 minute, 5 minutes, 10 minutes, 20 minutes, etc. The appointment service request may indicate that the user wishes to use the transportation service at a defined time which is reasonably far from the present moment for the ordinary person in the art. For example, a service request may be an appointment service request if the defined time is longer than a threshold value, such as 20 minutes, 2 hours, or 1 day.

In some embodiments, the target address query included in the transportation service request may refer to a name of an intended target destination of a target transportation trip associated with the transportation service request. In some embodiments, the target address query may include a name of a village, a name of a community, a name of a building (e.g., a hospital, a supermarket, a school, a station), a name of a scenery (e.g., a mountain, a river, a scenic spot), etc.

In some embodiments, the target address query may be inputted by a requester via the requester terminal 130. The requester may input the target address query via a typing input, a hand input, a voice input, a picture input, etc.

In 520, the processing engine 112 (e.g., the receiving module 410) (e.g., the processing circuits of the processor 220) may determine that the target address query is directed to a target AOI. As used herein, an AOI may refer to a region associated with which a region parameter (e.g., an area of the region, a largest distance between two points on a boundary of the region, an average travel time (e.g., an average walking time) between the two points) is greater than a threshold. For example, a region with an area larger than an area threshold (e.g., 1 km², 5 km², 10 km², 20 km²) may be designated as an AOI. As another example, it is assumed that a region is a rectangle region and a diagonal distance of the region is larger than a distance threshold (e.g., 1 km, 2 km, 5 km, 10 km), the region may be designated as an AOI. As a further example, it is assumed that a region is a rectangle region and an average walking time along a diagonal line of the region is larger than a time threshold (e.g., 10 minutes, 20 minutes, 30 minutes, 1 hour), the region may be designated as an AOI. The thresholds mentioned above may be default settings of the system 100, or may be adjustable under different situations. For example, for a city, the area threshold may be relatively small for an ordinary person in the art, whereas for a village, the area threshold may be relatively large for an ordinary person in the art.

In some embodiments, rather than a specific location, a name of the AOI may include a street name without a building number, a name of a district, a name of a village, a name of a community, a name of a shopping mall greater than a certain size, or a name of other geographic area large enough so that an ordinary person would have an idea of a rough location but would not be able to pinpoint the exact location as a destination to end a transportation trip. Accordingly, “the target address query is directed to a target AOI” may refer to that the name of the intended target destination is the same as or substantially similar to the name of the target AOI. As used herein, “substantially similar” refers to that a similarity between the name of the intended target destination and the name of the target AOI is larger than a threshold (e.g., 90%, 95%, 98%).

In 530, the processing engine 112 (e.g., the target POI determination module 430) (e.g., the interface circuits of the processor 220) may obtain at least one target POI and a target semantic description associated with the target AOI. As used herein, as described in connection with step 520, a POI may refer to a specific location or a region associated with which the region parameter is less than the threshold. In some embodiments, a name of the POI may include a building number, a name of a station board, a name of a crossroad, etc. In some embodiments, the AOI may include one or more POIs. For example, an AOI “Peking University” may include a POI “East Gate of Peking University ”, a POI “West Gate of Peking University”, a POI “South Gate of Peking University”, etc.

In some embodiments, the processing engine 112 may obtain the at least one target POI (i.e., a candidate POI described in FIG. 7 in detail) and the target semantic description associated with the target AOI from an AOI database. The AOI database may include data associated with a plurality of AOIs. Take the target AOI as an example, the AOI database includes target data which associate the target address query with the target AOI, and associate the target AOI with the at least one target POI and the target semantic description.

In some embodiments, the processing engine 112 may determine the AOI database based on a plurality of indexed historical transportation trip records, wherein each of the plurality of historical transportation trip records includes an address query from a user as a destination name of a transportation trip and an actual destination location that the transportation trip ended (see, e.g., FIG. 7 and the description thereof).

In some embodiments, the target POI may be a POI included in or near the target AOI. For example, it is assumed that the target address query is “Peking University,” the processing engine 112 determines that the target address query is directed to the AOI “Peking University.” Further, the processing engine 112 may determine a target POI “East Gate of Peking University” included in the target AOI from the AOI database. The target semantic description may be a description (e.g., a phrase, a sentence, a paragraph) associated with the target AOI which can help a user to realize that the at least one target POI is associated with the target AOI. In some embodiments, the target semantic description may be a name of the target AOI and/or a synonym of the name of the target AOI. For example, it is assumed that the target address query is “Central Business District,” accordingly, the target AOI may be “Central Business District,” and further, the target semantic description may be “Central Business District,” “CBD,” etc.

In some embodiments, in the AOI database, the target data may further associate at least one target location with the target AOI. The processing engine 112 may also obtain the at least one target location from the AOI database in response to the transportation service request. The target location may be a center location (i.e., a candidate destination point described in FIG.7 in detail) of a point cluster associated with a plurality of actual destination locations of the plurality of historical transportation trip records (see, e.g., FIG. 7 and the description thereof).

In 540, the processing engine 112 (e.g., the transmission module 440) (e.g., the interface circuits of the processor 220) may send the at least one target POI, the target semantic description, and/or the at least one target location to the requester terminal 130.

In some embodiments, the processing engine 112 may write the at least one target POI, the target semantic description, and/or the at least one target location to a cache (e.g., a cache memory of the processor 220) of the on-demand service system 100, and send the at least one target POI, the target semantic description, and/or the at least one target location as well as a command to an output port (e.g., an antenna) of the system 100, wherein the command is configured to direct the output port to send communication signals (e.g., an electronic signal, a wireless signal) to direct the requester terminal 130 to display on a screen of the requester terminal 130 the at least one target POI, the target semantic description, and/or the at least one target location as a recommended destination.

In some embodiments, the requester terminal 130 may display the at least one target POI, the target semantic description, and/or the at least one target location in a form of a text description, a graphical illustration on a map, an audio description, etc. In some embodiments, the requester terminal 130 may display the at least one target POI, the target semantic description, and/or the at least one target location via a user interface (e.g., a user interface 1000) on the requester terminal 130.

In some embodiments, the processing engine 112 may rank the at least one target POI based on heat information associated with the at least one target POI. As used herein, heat information associated with a POI may refer to a frequency that requesters used the POI as destinations of transportation trips within a predetermined time period (e.g., the last three months, the last six months, the last year) in a predetermined area (e.g., a city). For example, the higher the frequency of the target POI is, the higher the ranking of the target POI may be. In some embodiments, the processing engine 112 may rank the at least one target POI based on at least one cluster density associated with the at least one target POI (see, e.g., FIG.7 and the description thereof). For example, the larger the cluster density associated with the target POI is, the higher the ranking of the target POI may be. In some embodiments, the requester terminal 130 may display the at least one target POI based on the ranking of the at least one target POI. For example, the requester terminal 130 may display one or more (e.g., top 1, top 2, top 3) of the at least one target POI in red and display the remainder target POI(s) in grey.

In some embodiments, the service requester may further select one of the at least one target POI as a destination of the transportation service request via the user interface of the requester terminal 130.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 500. In the storing step, the processing engine 112 may store information (e.g., the target address query, the target POI, the target semantic description, the target location) associated with the transportation service request in a storage device (e.g., the storage 150) disclosed elsewhere in the present disclosure.

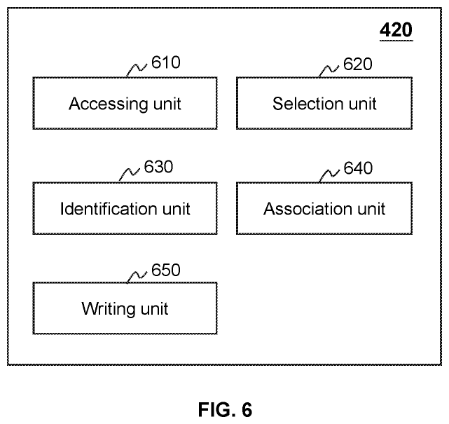

FIG. 6 is a block diagram illustrating an exemplary database determination module 420 according to some embodiments of the present disclosure. The database determination module 420 may include an accessing unit 610, a selection unit 620, an identification unit 630, an association unit 640, and a writing unit 650.

The accessing unit 610 may be configured to access a record database including a plurality of indexed historical transportation trip records. The record database may be stored in the storage 150, the storage module (not shown) of the processing engine 112, an external data source, etc. The record database may include one or more data sheets storing the plurality of historical transportation trip records, wherein a historical trip record may be stored in a row of the data sheet. Each of the plurality of indexed historical transportation trip records may include an address query from a requester as a destination name of a transportation trip and/or an actual destination location that the transportation trip ended.

The selection unit 620 may be configured to obtain a set of historical transportation trip records from the record database, wherein the address query of each of the set of historical transportation trip records semantically directs to a same AOI. The selection unit 620 may determine whether the address query of each of the plurality of historical transportation trip records corresponds to an AOI (or a region corresponding to an AOI) and select the set of historical transportation trip records of which the address queries semantically direct to a same AOI.

The identification unit 630 may be configured to identify one or more candidate destination points based on a distribution of the actual destination locations corresponding to the set of historical transportation trip records. For example, the identification unit 630 may cluster the actual destinations corresponding to the set of historical transportation trip records into one or more point clusters based on a clustering technique and determine the one or more candidate destination points based on the one or more point clusters.

In some embodiments, the identification unit 630 may further identify one or more candidate POIs based on the one or more candidate destination points, wherein the one or more candidate POIs are different from the one or more candidate destination points. For example, for each of the one or more candidate destination points, the identification unit 630 may identify at least one POI with a distance from the candidate destination point less than a distance threshold (e.g., 5 m, 10 m, 20 m, 50 m, 100 m, 200 m) as a candidate POI.

The association unit 640 may be configured to associate a semantic description associated with the AOI with the one or more candidate POIs. As used herein, the semantic description may be a description (e.g., a phase, a sentence, a paragraph) associated with the AOI which can help a user to realize that the one or more candidate POIs are associated with the AOI. In some embodiments, the semantic description may be a name of the AOI and/or a synonym of the name of the AOI.

The writing unit 650 may be configured to write a data structure including the address query, the one or more candidate POIs, the AOI, the semantic description, and the one or more candidate destination points in at least one non-transitory storage medium.

The units in the database determination module 420 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the units may be combined into a single module, and any one of the units may be divided into two or more sub-units. For example, the accessing unit 610 and the selection unit 620 may be combined as a single module which may both access a record database and obtain a set of historical transportation records from the record database.

FIG. 7 is a flowchart illustrating an exemplary process for establishing an A01 database according to some embodiments of the present disclosure. In some embodiments, the process 700 may be implemented as a set of instructions (e.g., an application) stored in the storage ROM 230 or RAM 240. The processor 220 and/or the units in FIG. 6 may execute the set of instructions, and when executing the instructions, the processor 220 and/or the units may be configured to perform the process 700. The operations of the illustrated process present below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting.

In 710, the processing engine 112 (e.g., the accessing unit 610) (e.g., the interface circuits of the processor 220) may access a record database including a plurality of indexed historical transportation trip records. The record database may be stored in the storage 150, the storage module (not shown) of the processing engine 112, an external data source, etc. The record database may include one or more data sheets storing the plurality of historical transportation trip records, wherein a historical trip record may be stored in a row of the data sheet. The plurality of indexed historical transportation trip records may include any information associated with historical transportation trips within a predetermined time period (e.g., the last three months, the last six months, the last year) in a predetermined area (e.g., a city).

In some embodiments, each of the plurality of historical transportation trip records may include an address query (e.g., an address search query inputted by the requester) from a requester as a destination name of a transportation trip and an actual destination location that the transportation trip ended. In some embodiments, each of the plurality of historical transportation trip records may further include a historical start time of the transportation trip, a historical start location of the transportation trip, a historical pick-up location of the transportation trip, a historical service fee of the transportation trip, etc. The address query, the actual destination location, the historical start time, the historical start location, the historical pick-up location, and/or the historical service fee may correspond to one or more fields of the one or more data sheets.

In 720, the processing engine 112 (e.g., the selection unit 620) (e.g., the interface circuits of the processor 220) may obtain a set of historical transportation trip records from the record database, wherein the address query of each of the set of historical transportation trip records semantically directs to a same AOI. For example, the processor 220 may obtain the set of historical transportation trip records via the bus 210.

In some embodiments, the processing engine 112 may determine whether the address query of each of the plurality of indexed historical transportation trip records corresponds to an AOI (or a region corresponding to an AOI). As described in connection with step 520, an AOI may refer to a region associated with which a region parameter (e.g., an area of the region, a largest distance between two points on a boundary of the region, an average travel time (e.g., an average walking time) between the two points) is greater than a threshold. Accordingly, take a specific historical transportation trip record as an example, the processing engine 112 may determine whether the address query of the historical transportation trip record corresponds to an AOI based on a parameter (e.g., a category of the address query, a name of the address query, a distance between the address query and the actual destination location of the historical transportation trip record) associated with the address query. As used herein, “the distance between the address query and the actual destination location” refers to a distance between a center location of the address query and the actual destination location.

For example, it is assumed that the category of the address query is a road category, an administrative category (e.g., a district, a village, a town), etc., indicating that the address query describes a region associated with which the region parameter (e.g., the area of the region) is larger than the threshold, the processing engine 112 may determine that the address query corresponds to an AOI. As another example, it is assumed that the name of the address query is a shopping mall, a community, etc., indicating that the address query describes a region associated with which the region parameter (e.g., the area of the region) is larger than the threshold, the processing engine 112 may determine that the address query corresponds to an AOI. As a further example, it is assumed that the distance between the address query and the actual destination location of the historical transportation trip record is larger than a distance threshold (e.g., 500 m, 1 km, 1.5 km, 2 km), the processing engine 112 may determine that the address query corresponds to an AOI.

After determining whether the address query of each of the plurality of indexed historical transportation trip records corresponds to an AOI, the processing engine 112 may select the set of historical transportation trip records of which the address queries semantically direct to a same AOI. As described in connection with step 520, for the set of historical transportation trip records, names of the address queries are the same as or substantially similar to a name of the same AOI.

In 730, the processing engine 112 (e.g., the identification unit 630) (e.g., the processing circuits of the processor 220) may identify one or more candidate destination points based on a distribution of the actual destination locations corresponding to the set of historical transportation records.

In some embodiments, the processing engine 112 may cluster the actual destinations corresponding to the set of historical transportation trip records into one or more point clusters based on a clustering technique and determine the one or more candidate destination points based on the one or more point clusters. The clustering technique may include k-means algorithm, Hierarchical clustering algorithm, Self-Organizing Maps (SOM), Fuzzy C-means (FCM), or the like, or any combination thereof.

For example, the processing engine 112 may select one or more target point clusters from the one or more point clusters based on, for example, Density Peaks Clustering Algorithm (DPC), wherein densities of the one or more target point clusters are larger than a density threshold. The density threshold may be default settings of the on-demand service system 100, or may be adjustable under different situations. For example, for a city, the density threshold may be relatively large for an ordinary person in the art, whereas for a village, the density threshold may be relatively small for an ordinary person in the art. The processing engine 112 may further determine one or more center coordinates of the one or more target point clusters and determine the one or more candidate destination points based on the one or more center coordinates.

In 740, the processing engine 112 (e.g., the identification unit 630) (e.g., the processing circuits of the processor 220) may identify one or more candidate POIs based on the one or more candidate destination points, wherein the one or more candidate POIs are different from the one or more candidate destination points. For each of the one or more candidate destination points, the processing engine 112 may identify at least one POI with a distance from the candidate destination point less than a distance threshold (e.g., 5 m, 10 m, 20 m, 50 m, 100 m, 200 m) as a candidate POI. The distance threshold may be default settings of the on-demand service system 100, or may be adjustable under different situations. For example, for a city, the distance threshold may be relatively small for an ordinary person in the art, whereas for a village, the distance threshold may be relatively large for an ordinary person in the art.

In some embodiments, the processing engine 112 may rank the one or more candidate POIs based on heat information associated with the one or more candidate POIs. As described in connection with step 540, heat information associated with a POI may refer to a frequency that requesters used the POI as destinations of transportation trips within a predetermined time period (e.g., the last three months, the last six months, the last year) in a predetermined area (e.g., a city). For example, the higher the frequency of the candidate POI is, the higher the ranking of the candidate POI may be. In some embodiments, the processing engine 112 may rank the one or more candidate POIs based on cluster densities of the one or more target point clusters corresponding to the one or more candidate destination points. For example, the larger the cluster density is, the higher the ranking of the candidate POI may be.

In 750, the processing engine 112 (e.g., the association unit 640) (e.g., the processing circuits of the processor 220) may associate a semantic description associated with the AOI with the one or more candidate POIs. As used herein, the semantic description may be a description (e.g., a phase, a sentence, a paragraph) associated with the AOI which can help a user to realize that the one or more candidate POIs are associated with the AOI. In some embodiments, the semantic description may be a name of the AOI and/or a synonym of the name of the AOI.

In 760, the processing engine 112 (e.g., the writing unit 650) (e.g., the processing circuits of the processor 220) may write a data structure including the address query, the one or more candidate POIs, the AOI, the semantic description, and the one or more candidate destination points in at least one non-transitory storage medium. The data structure may be a way of organizing and storing data in a computer so that it can be accessed and modified efficiently. In particular, the data structure may be a collection of data elements (i.e., the address query, the one or more candidate POIs, the AOI, the semantic description, and the one or more candidate destination points) and the relationships among them.

In some embodiments, the data structure may include at least one first byte recording the address query, at least one second byte recording the one or more candidate POIs, at least one third byte recording the AOI, at least one fourth byte recording the semantic description, at least one fifth byte recording the one or more candidate destination points, etc.

As described in connection with FIG. 5, after receiving a transportation service request, the processing engine 112 may access the AOI database and determine the at least one target POI (i.e., the candidate POI), the target semantic description, and/or the target location (i.e., the candidate destination point) from the AOI database.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, step 730 and step 740 may be combined as a single step in which the processing engine 112 may both identify the one or more candidate destination points and identify the one or more candidate POIs based on the one or more candidate destination points.

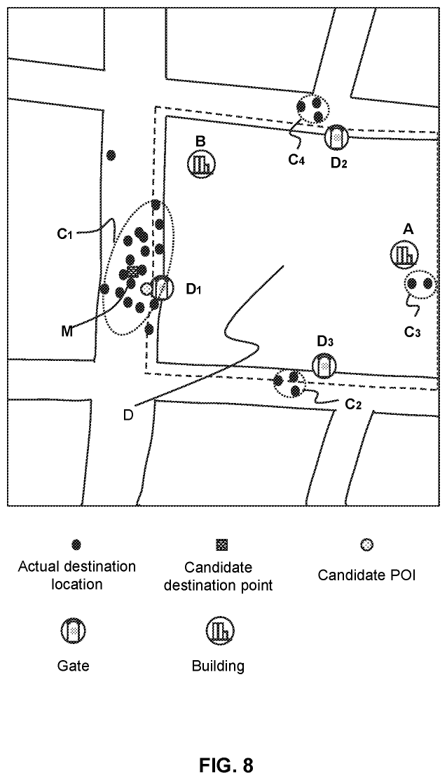

FIG. 8 is a schematic diagram illustrating an exemplary process for determining a candidate POI according to some embodiments of the present disclosure. As illustrated in FIG. 8, a dashed box refers to an AOI D, and the AOI D includes a POI A (a building), a POI B (a building), a POI D₁ (a west gate), a POI D₂ (a north gate), and a POI D₃ (a south gate). As described in connection with step 740, in order to determine one or more candidate POIs associated with the AOI D, the processing engine 112 may obtain a set of historical transportation trip records from the record database, wherein the address query of each of the set of historical transportation trip records semantically directs to the AOI D. The processing engine 112 may cluster actual destination locations (e.g., solid dots illustrated in FIG. 8) corresponding to the set of historical transportation trip records into point clusters (e.g., C₁, C₂, C₃, and C₄) and determine a target point cluster C₁ with a cluster density larger than a predetermined threshold. Further, the processing engine 112 determine a center coordinate M of the target point cluster C₁ as a candidate destination point and identify a candidate POI D₁ with a distance from the candidate destination point less than a predetermined threshold.

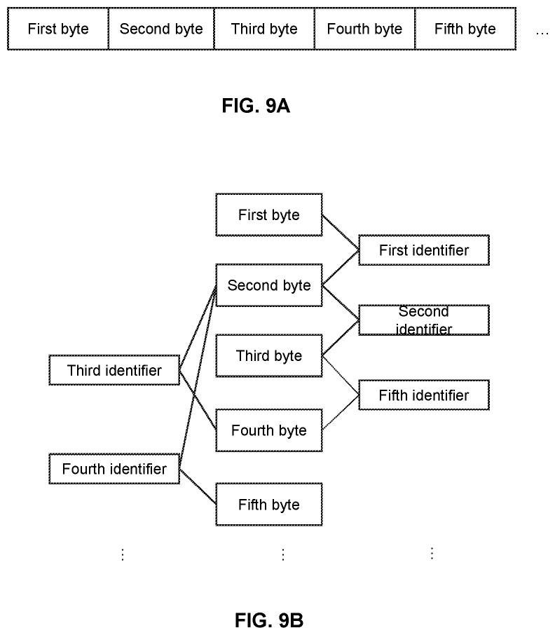

FIG. 9A and FIG. 9B are schematic diagrams illustrating exemplary data structures according to some embodiments of the present disclosure. The data structure may include at least one first byte recording the address query, at least one second byte recording the one or more candidate POIs, at least one third byte recording the AOI, at least one fourth byte recording the semantic description, at least one fifth byte recording the one or more candidate destination points, etc. As illustrated in FIG. 9A, the bytes may be stored in a data sheet in order. As illustrated in FIG. 9B, the bytes may be stored in different data sheets and the bytes may be associated with each other via one or more identifiers. For example, a first identifier may associate the at least one first byte with the at least one second byte; a second identifier may associate the at least one second byte with the at least one third byte; a third identifier may associate the at least one second byte with the at least one fourth byte; a fourth identifier associated the at least one second byte with the at least one fifth byte, a fifth identifier associated with the at least one third byte with the at least one fourth byte, etc.

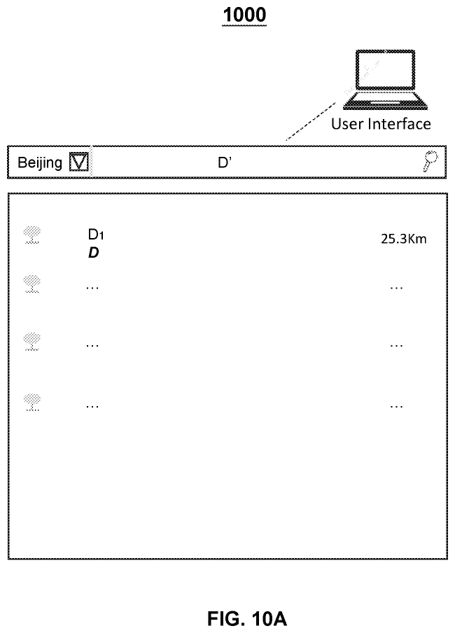

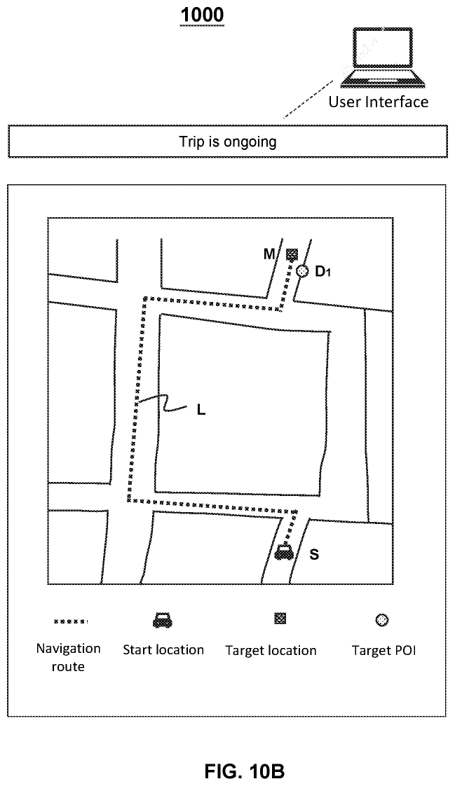

FIG. 10A and FIG. 10B are a schematic diagrams illustrating an exemplary user interface 1000 for recommending at least one target POI, a target semantic description, and a target location to a requester according to some embodiments of the present disclosure. As illustrated in FIG. 10A, it is assumed that the requester inputs a target address query D′ via the user interface 1000 and the processing engine 112 determines that the target address query D′ is directed to the AOI D. Further, the processing engine 112 may recommend at least one target POI (e.g., the POI D₁) and a target semantic description “D” (i.e., a name of the AOI D) in response to the target address query. As illustrated in FIG. 10B, the processing engine 112 may further send a target location (i.e., the candidate destination point M illustrated in FIG. 8) to the requester terminal 130 to be displayed via the user interface 1000. Accordingly, the processing engine 112 may provide a navigation route L from a start location S to the target location.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1-20. (canceled)

21. A system configured to provide online on-demand transportation service to a user, comprising:
at least one non-transitory storage medium including a set of instructions; and
at least one processor in communication with the at least one non-transitory storage medium, wherein when executing the set of instructions, the at least one processor is directed to:
receive and accept a communication request from a user terminal;
detect a customer application executing on the user terminal, the customer application collecting user input from the user terminal from one or more sensors of the user terminal and automatically communicating with the system over a network;
communicate with the customer application executing on the user terminal to receive a transportation service request including a target address query input by a user;
access an area of interest (AOI) database to obtain target data, wherein the target data associate the target address query with a target AOI, and associate the target AOI with at least one target point of interest (POI) and a target semantic description associated with the target AOI;
write the target AOI, the at least one target POI, and the target semantic description to a cache of the system; and
send the at least one target POI and the target semantic description as well as a command to an output port of the system, wherein the command is configured to direct the output port to send communication signals to direct the user terminal to display on a screen of the user terminal the at least one target POI as well as the target semantic description as a recommended destination of the transportation service request.

22. The system of claim 21, wherein the target data further associate the target AOI with at least one target location and
wherein the at least one processor is further directed to:
write the at least one target location to the cache of the system; and
send the at least one target location to the output port of the system, wherein the command is further configured to direct the output port to send communication signals to direct the user terminal to display on the screen of the user terminal the at least one target location.

23. The system of claim 21, wherein the processor is further directed to establish the AOI database, and
wherein to establish the AOI database, the at least one processor is directed to:
access a record database that includes a plurality of indexed historical transportation trip records, each of the plurality of historical transportation trip records includes an address query from a user as a destination name of a transportation trip and actual destination location that the transportation trip ended;
obtain a set of historical transportation trip records from the record database, wherein the address query of each of the set of historical transportation trip records semantically directs to a same AOI;
identify one or more candidate destination points based on a distribution of the actual destination locations corresponding to the set of historical transportation trip records;
identify one or more candidate POIs based on the one or more candidate destination points;
associate a semantic description associated with the AOI with the one or more candidate POIs; and
write in the at least one non-transitory storage medium a data structure including
at least one first byte recording the address query;
at least one second byte recording the one or more candidate POIs;
at least one third byte recording the AOI;
at least one fourth byte recording the semantic description; and
at least one fifth byte recording the one or more candidate destination points.

24. The system of claim 23, wherein the data structure further includes:
a first identifier associated the at least one first byte with the at least one second byte;
a second identifier associated the at least one second byte with the at least one third byte;
a third identifier associated the at least one second byte with the at least one fourth byte;
a fourth identifier associated the at least one second byte with the at least one fifth byte; and
a fifth identifier associated with the at least one third byte with the at least one fourth byte.

25. The system of claim 23 wherein to identify the one or more candidate destination points, the at least one processor is directed to:
cluster the actual destination locations corresponding to the set of historical transportation trip records into one or more point clusters; and
determine the one or more candidate destination points based on the one or more point clusters.

26. The system of claim 25, wherein to identify the one or more candidate destination points, the at least one processor is directed to:
select one or more target point clusters from the one or more point clusters, wherein densities of the one or more target point clusters are larger than a first threshold;
determine one or more center coordinates of the one or more target point clusters; and
determine the one or more candidate destination points based on the one or more center coordinates.

27. The system of claim 23, wherein to identify the one or more candidate POIs based on the one or more candidate destination points, the at least one processor is directed to:
for each of the one or more candidate destination points,
identify at least one POI with a distance from the candidate destination point less than a second threshold as a candidate POI.

28. The system of claim 23, wherein the AOI is associated with an area greater than a threshold area.

29. The system of claim 23, wherein the AOI includes one or more POIs.

30. The system of claim 23, wherein the one or more candidate POIs are different from the one or more candidate destination points.

31. A method implemented on a computing device having at least one processor, at least one storage medium, and a communication platform connected to a network, the method comprising:
receiving and accept a communication request from a user terminal;
detecting a customer application executing on the user terminal, the customer application collecting user input from the user terminal from one or more sensors of the user terminal and automatically communicating with the system over a network;
communicating with the customer application executing on the user terminal to receive a transportation service request including a target address query input by a user;
accessing an area of interest (AOI) database to obtain target data, wherein the target data associate the target address query with a target AOI, and associate the target AOI with at least one target point of interest (POI) and a target semantic description associated with the target AOI;
writing the target AOI, the at least one target POI, and the target semantic description to a cache of the system; and
sending the at least one target POI and the target semantic description as well as a command to an output port of the system, wherein the command is configured to direct the output port to send communication signals to direct the user terminal to display on a screen of the user terminal the at least one target POI as well as the target semantic description as a recommended destination of the at least one target POI.

32. The method of claim 31, wherein the target data further associate the target AOI with at least one target location and
wherein the method further includes:
writing the at least one target location to the cache of the system; and
sending the at least one target location to the output port of the system, wherein the command is further configured to direct the output port to send communication signals to direct the user terminal to display on the screen of the user terminal the at least one target location.

33. The method of claim 31, wherein the method further includes establishing the AOI database, and
wherein the establishing the AOI database includes:
accessing a record database that includes a plurality of indexed historical transportation trip records, each of the plurality of historical transportation trip records includes an address query from a user as a destination name of a transportation trip and actual destination location that the transportation trip ended;
obtaining a set of historical transportation trip records from the record database, wherein the address query of each of the set of historical transportation trip records semantically directs to a same AOI;
identifying one or more candidate destination points based on a distribution of the actual destination locations corresponding to the set of historical transportation trip records;
identifying one or more candidate POIs based on the one or more candidate destination points;
associating a semantic description associated with the AOI with the one or more candidate POIs; and
writing in the at least one non-transitory storage medium a data structure including
at least one first byte recording the address query;
at least one second byte recording the one or more candidate POIs;
at least one third byte recording the AOI;
at least one fourth byte recording the semantic description; and
at least one fifth byte recording the one or more candidate destination points.

34. The method of claim 33, wherein the data structure further includes:
a first identifier associated the at least one first byte with the at least one second byte;
a second identifier associated the at least one second byte with the at least one third byte;
a third identifier associated the at least one second byte with the at least one fourth byte;
a fourth identifier associated the at least one second byte with the at least one fifth byte; and
a fifth identifier associated with the at least one third byte with the at least one fourth byte.

35. The method of claim 33, wherein the identifying the one or more candidate destination points includes:
clustering the actual destination locations corresponding to the set of historical transportation trip records into one or more point clusters; and
determining the one or more candidate destination points based on the one or more point clusters.

36. The method of claim 35, wherein the identifying the one or more candidate destination points includes:
selecting one or more target point clusters from the one or more point clusters, wherein densities of the one or more target point clusters are larger than a first threshold;
determining one or more center coordinates of the one or more target point clusters; and
determining the one or more candidate destination points based on the one or more center coordinates.

37. The method of claim 33, wherein the identifying the one or more candidate POIs based on the one or more candidate destination points includes:
for each of the one or more candidate destination points,
identifying at least one POI with a distance from the candidate destination point less than a second threshold as a candidate POI.

38. The method of claim 33, wherein the AOI is associated with an area greater than a threshold area.

39. The method of claim 33, wherein the AOI includes one or more POIs.

40. (canceled)

41. A non-transitory computer-readable storage medium storing instructions that, when executed by at least one processor of a system, cause the system to perform a method, the method comprising:
receiving and accept a communication request from a user terminal;
detecting a customer application executing on the user terminal, the customer application collecting user input from the user terminal from one or more sensors of the user terminal and automatically communicating with the system over a network;
communicating with the customer application executing on the user terminal to receive a transportation service request including a target address query input by a user;
accessing an area of interest (AOI) database to obtain target data, wherein the target data associate the target address query with a target AOI, and associate the target AOI with at least one target point of interest (POI) and a target semantic description associated with the target AOI;
writing the target AOI, the at least one target POI, and the target semantic description to a cache of the system; and
sending the at least one target POI and the target semantic description as well as a command to an output port of the system, wherein the command is configured to direct the output port to send communication signals to direct the user terminal to display on a screen of the user terminal the at least one target POI as well as the target semantic description as a recommended destination of the at least one target POI.
